(19) United States
(12) Patent Application Publication
(10) Pub. No.: US 2008/0240643 A1
(43) Pub. Date: Oct. 2, 2008

(54) HOOD FOR A PRESSURIZED BEARING ASSEMBLY

(75) Inventor: John Henry GARNCARZ, Massillon, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Wayne-Dalton Corp, Mt. Hope, OH (US)

(21) Appl. No.: 12/136,621

(22) Filed: Jun. 10, 2008

Related U.S. Application Data
(63) Continuation-in-part of application No. 11/819,029, filed on Jun. 25, 2007.
(60) Provisional application No. 60/828,290, filed on Oct. 5, 2006.
(60) Provisional application No. 60/915,485, filed on May 2, 2007.

(51) Int. Cl. F16C 35/00; F16C 33/76

(52) U.S. Cl. 384/624; 384/471

(57) ABSTRACT

A hood for a bearing assembly isolates lubricants or gases expelled from the bearing assembly. The hood may include lower, middle, and upper portions that substantially form a funnel. The hood covers at least a portion of a bearing seal of the bearing assembly and extends from the bearing assembly and out of a galvanizing bath. The hood may be formed from one or more sheets of material. Mounting brackets are provided to secure the hood to the bearing.

### RELATED APPLICATIONS

This application is a continuation-in-part of U.S. patent application Ser. No. 11/819,029, pending, filed Jun. 25, 2007, and titled “Pressurized Bearing Assembly,” which claims priority to U.S. Provisional Patent Application Ser. No. 60/828,290, filed Oct. 5, 2006, titled “Extended Life Bearing Isolation and Housing Device For Use In Molten Metal Baths” and to U.S. Provisional Patent Application Ser. No. 60/915,485, filed May 2, 2007, titled “A Pressurized Mechanical Seal For Use In Molten Metal Baths,” the disclosures of each are hereby incorporated by reference in their entirety.

### FIELD OF THE INVENTION

The invention relates generally to a seal for a roller or conveyor device used in molten metal galvanizing baths. More particularly, the invention relates to a hood for the seal that isolates any expelled lubricants or gas from a steel coil being galvanized.

### BACKGROUND OF THE INVENTION

In continuous hot-dip galvanizing of a steel strip, a bath of molten zinc is used. Prior to entering the bath, the strip typically undergoes a heat treatment in a furnace. An end portion of the furnace that extends into the bath, called a snout, seals the furnace from the surrounding air. As the strip passes through the snout, the strip becomes immersed in the bath. Typically, two or more rolls are disposed in the molten bath. A sink roll reverses the travel direction of the strip in the bath, and a pair of stabilizing rolls in the bath stabilize and guide the strip through coating knives.

In the production of galvanized products, aluminum is typically present in the molten zinc bath for controlling zinc-iron alloy growth. Interfacial zinc-iron alloy on galvanized steel is undesirable because it causes low adherence of the zinc coating to the strip. In conventional hot-dip galvanizing processes, high bath temperatures can decrease roll life by increasing abrasion and erosion. Also, other components in the bath, such as bearings and sleeves, have decreased lives because of high bath temperatures and dross formation. The decreased lives of such components increases costs directly (e.g., replacement costs) and indirectly (e.g., cessation of production when replacing the components).

Rollers used on conveyors and inside a zinc-pot of a steel-sheet galvanizing line are usually driven only by friction between the roller and a belt or sheet. Bearing friction torque and associated wear depends mostly on: roller load, roller weight, contacting bearing materials, surface finish and bearing diameter. Bearing wear rate is greatly affected by bearing materials, lubrication, temperature, velocity, average contact pressure and degree of clearance and roundness of a bearing sleeve inside each bearing housing. Bearing wear rate increases dramatically with miss-alignment of the bearing housings and with shaft deflection. Rollers operating in high temperature furnaces or in a hot zinc-pot of a steel galvanizing line often have negligible lubrication. In such cases, bearing life may be limited to only one week of operation before needing replacement. Additionally, the bearing seal may expel minute quantities of lubricants or gases that may contact metals being galvanized and reduce the quality of the galvanizing process.

### SUMMARY OF THE INVENTION

The foregoing disadvantages are overcome, to a great extent, by the invention, wherein in one aspect a pressurized bearing assembly for use with a zinc pot of a steel sheet galvanizing line is provided that in some embodiments includes a pressurized housing. The pressurized housing is preferably formed of a temperature and corrosion resistant material. The housing may include first and second portions having a housing seal therebetween. The first and second portions may be secured together using any suitable fastening mechanism. The first and second portions may include receiving portions for receiving a shaft of a conveyor used in the galvanizing line as well as roller (or other types of) bearings. The housing may also include an attachment mechanism for attaching the bearing assembly to, for example, a swing arm of the conveyor.

The housing may include a chamber for storing pressurized air and/or a lubricant. A bearing seal may be provided to substantially isolate the roller bearings provided in the housing from a corrosive and abrasive environment created by, for example, a steel sheet galvanizing line. The pressurized chamber assists in preventing corrosive and abrasive materials from causing wear to the bearings. The bearing seal may include, for example, metal bellows, labyrinth or other type of seal with or without thrust bearings.

The chamber may also be in fluid communication with, for example, a closed-loop lubrication system. The closed-loop lubrication system may be used to circulate a lubricant such as, for example, oil, throughout the chamber and provide better lubrication for the bearings and to remove potential contaminants from the bearings.

According to another embodiment of the invention, the bearing seal may be formed using, for example, a stator and a rotor. The bearing seal may be provided on one side of the housing and receives, for example, a shaft of a zinc pot roller. The rotor may be provided with, for example, one or more fins that act as an expeller device that may be used to prevent molten metal from a zinc pot steel sheet galvanizing line from causing wear to the roller (or other types) of bearings. The rotor may be used in combination with the pressurized housing to prevent molten metal or other corrosive and abrasive materials from reaching the roller bearings. The rotor and stator together may also be pressurized and connected to the closed-loop lubrication system.

According to another embodiment of the invention, the bearing seal may include a hood that captures lubricants or gases expelled from the bearing. The hood may prevent the lubricants or gases from contacting the metal being galvanized to increase the quality of the galvanizing process. The hood may include lower, middle, and upper portions that substantially form a funnel. The funnel extends from the bearing and out of the galvanizing bath. The hood may be formed from one or more sheets of material. Mounting brackets are provided to secure the hood to the bearing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view of a bearing assembly according to one embodiment of the invention.

FIG. 2 is an end view of the bearing assembly shown in FIG. 1.

FIG. 3 is a top perspective view of a bearing assembly according to one embodiment of the invention.

FIG. 4 is a top perspective view of a top portion of a housing that may be used with a bearing assembly according to one embodiment of the invention.

FIG. 5 is a top perspective view of a bottom portion of a housing that may be used with a bearing assembly according to one embodiment of the invention.

FIG. 6 is a top perspective view of a stator that may be used with a bearing assembly according to one embodiment of the invention.

FIG. 7 is a top perspective view of a rotor that may be used with a bearing assembly according to one embodiment of the invention.

FIG. 8 is a partial cross-sectional view of a bearing assembly according to one embodiment of the invention.

FIG. 9 is a cross-sectional view of a bearing assembly according to one embodiment of the invention.

FIG. 10 illustrates a steel sheet galvanizing line using the bearing assemblies according to one embodiment of the invention.

FIG. 11 is a top perspective view of a hood for a seal according to one embodiment of the invention.

FIG. 12 is a top perspective view of a hood for a seal according to one embodiment of the invention.

FIG. 13 is a top perspective view of a lower portion of a hood for a seal according to one embodiment of the invention.

FIG. 14 is a top perspective view of an upper portion of a hood for a seal according to one embodiment of the invention.

FIG. 15 is a side perspective view of a hood attached to a seal according to one embodiment of the invention.

### DETAILED DESCRIPTION OF THE INVENTION

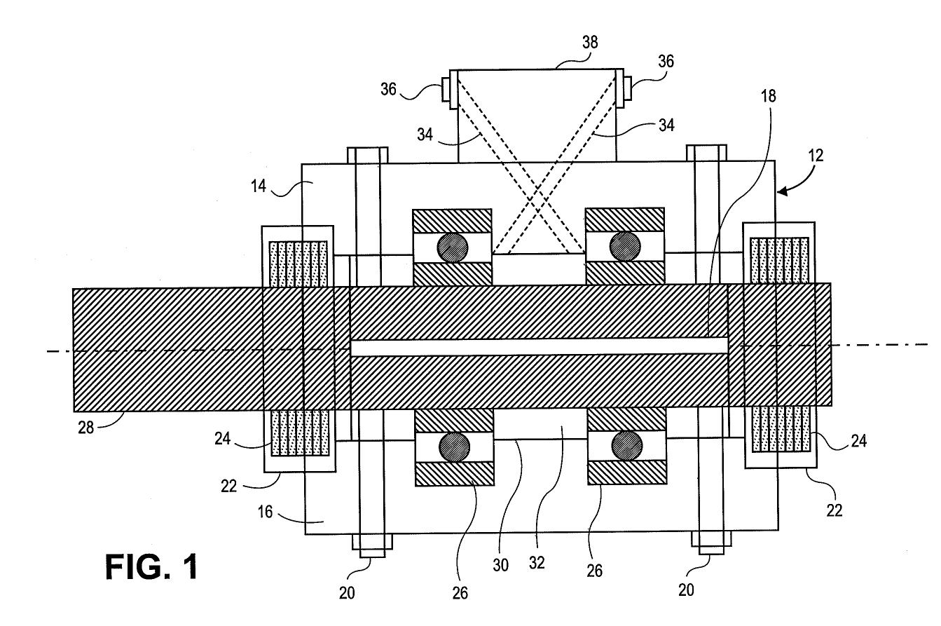

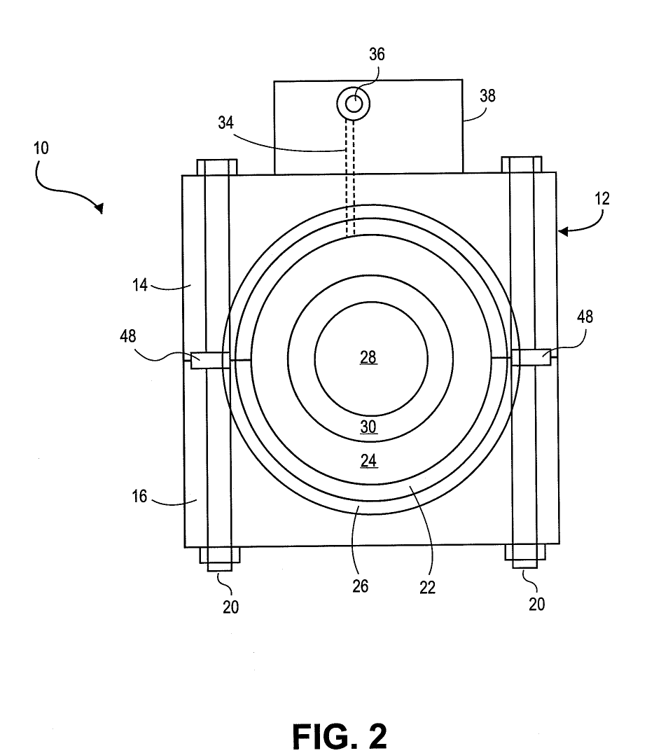

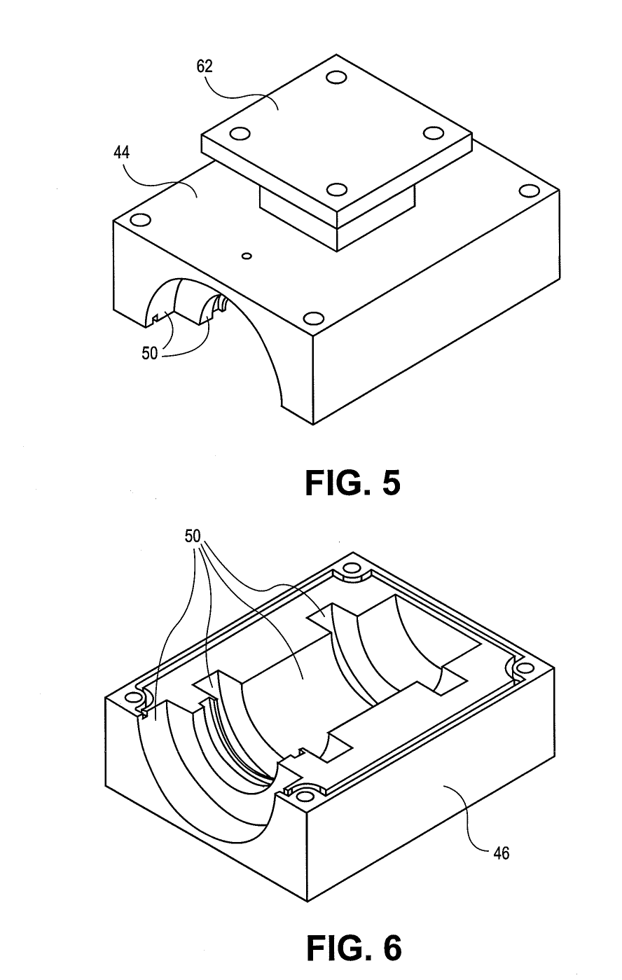

FIGS. 1 and 2 illustrate a bearing assembly 10 for use in molten metal baths according to one embodiment of the invention. The bearing assembly 10 includes a housing 12 having a top portion 14 and a bottom portion 16. The top portion 14 and the bottom portion 16 are preferably separated by a housing seal 18. The housing seal 18 may be used to prevent corrosive, abrasive, and other materials from entering the housing 12. The top portion 14 and the bottom portion 16 may include receiving portions (shown in FIGS. 5 and 6) that receive components of the bearing assembly 10. The top portion 14 and the bottom portion 16 may be attached using, for example, fasteners 20 or other suitable fastening mechanisms. The fasteners 20 may include, for example, a bolt and nut assembly.

The bearing assembly 10 may also include bearing seals 22 that may be provided on each end of the housing 12. The bearing seals 22 may include thrust bearings 24. The bearing seals 22 serve to substantially prevent corrosive and abrasive materials from entering the housing and causing wear to bearings 26. According to one embodiment of the invention, bearings 26 are roller bearings, although other types of bearings may also be used. The bearing seals 22 and the bearings 26 may be provided about a shaft 28 of a roller conveyor or other device.

The bearings 26 may be at least partially provided in a chamber 30 created by the top portion 14 and the bottom portion 16 of the housing 12. The chamber 30 may be used to store pressurized air and/or a lubricant 32. The lubricant 32 may be provided to the chamber 30 using passageways 34. The passageways may be in fluid communication with fittings 36 that are in fluid communication with a lubricant source (not shown) and provided on, for example, a swing arm 38 of a roller conveyor or other device.

The housing 12 is preferably formed of a temperature and corrosion resistant material and may be provided with an anti-wetting compound. The chamber 30 of the housing 12 is preferably pressurized to substantially isolate the bearings 26 and substantially prevent abrasive and corrosive materials from entering the chamber 30 and causing wear to the bearings 26.

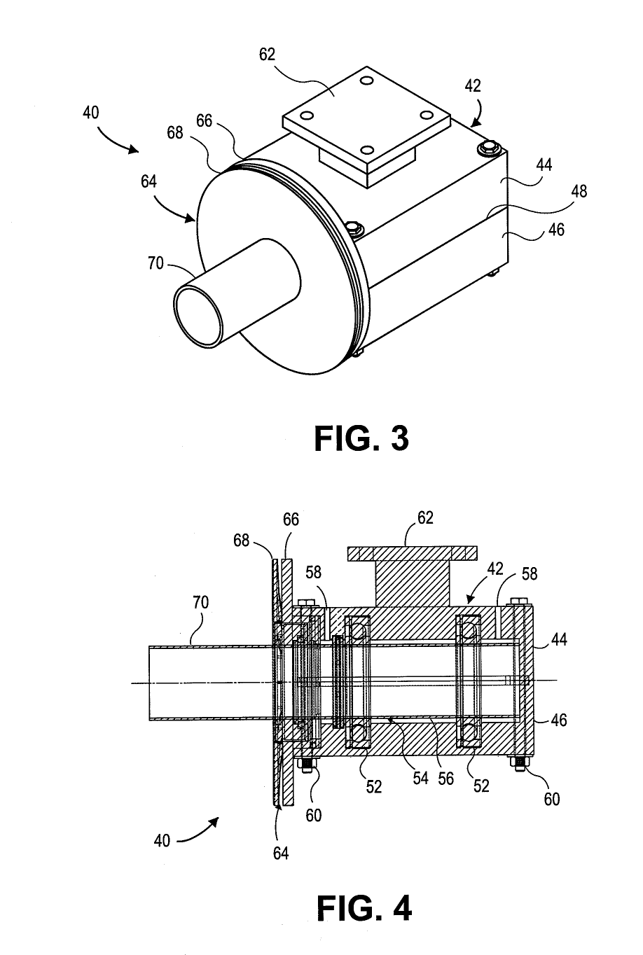

FIGS. 3 and 4 illustrate a bearing assembly 40 that may be used in a molten metal bath according to one embodiment of the invention. The bearing assembly 40 may include a housing 42 that may be formed from a top portion 44 (shown in further detail in FIG. 5) and a bottom portion 46 (shown in further detail in FIG. 6).

The top portion 44 and the bottom portion 46 may include a housing seal 48 positioned therebetween. The housing seal 48 may be used to reduce or prevent corrosive, abrasive or other materials from entering the housing 42. According to one embodiment of the invention, the housing seal 48 includes a gasket that may be, for example, a carbon fiber cloth having a shape corresponding to an outer edge of the top portion 44 and the bottom portion 46.

The top portion 44 and the bottom portion 46 preferably include receiving portions 50 (shown in FIGS. 5 and 6) The receiving portions 50 may be used to receive components such as, for example, bearings 52 (which may be roller bearings), of the bearing assembly 40. The receiving portions 50 may also be used to create a chamber 54 within the housing 42. The chamber 54 may be used to store pressurized air and/or a lubricant 56. The air and/or lubricant 56 may enter and exit the chamber 54 through passageways 58.

The top portion 44 and the bottom portion 46 may be attached using fasteners 60 or other suitable fastening mechanism. The top portion 44 may also include an attachment mechanism 62 that enables the bearing assembly 40 to be attached to, for example, a swing arm of a roller conveyor or other device.

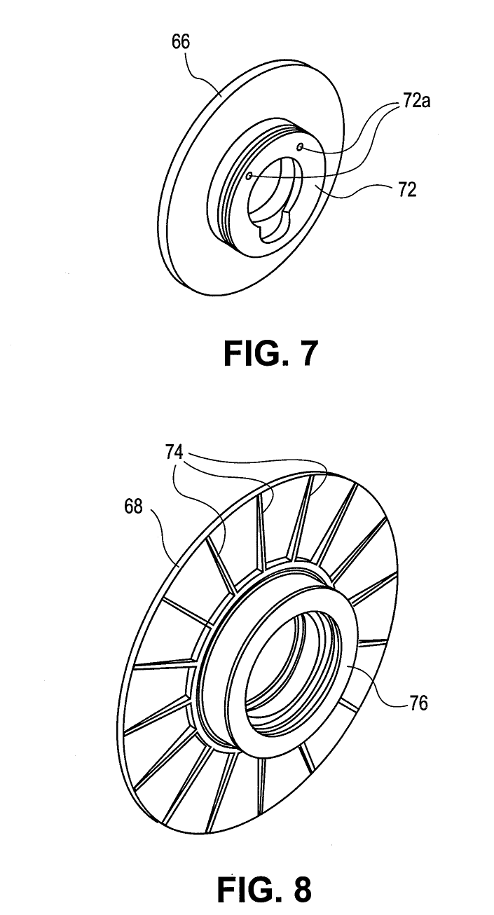

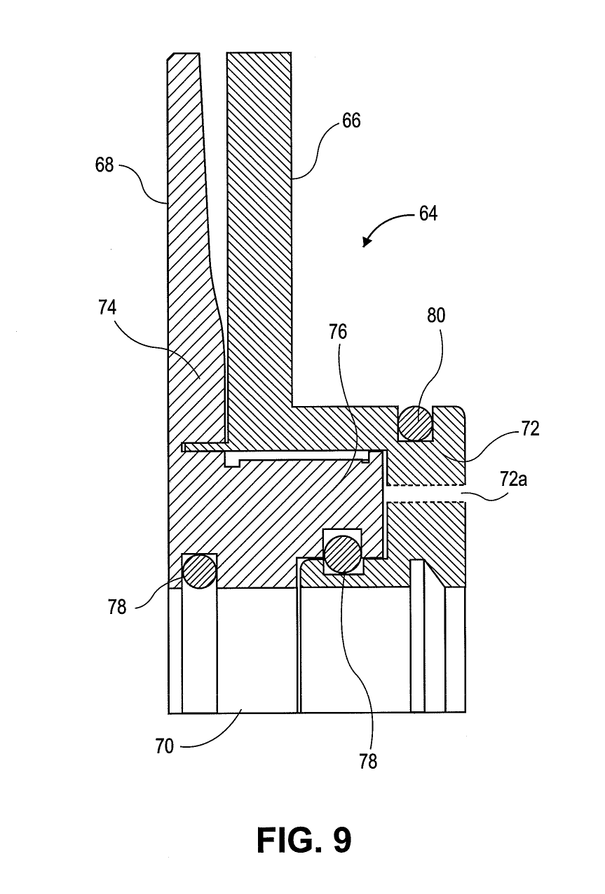

The bearing assembly 40 may also include a bearing seal 64 provided on, for example, one side of the housing 42. The bearing seal 64 may include a stator 66 and a rotor 68. The stator 66 and rotor 68 may receive a shaft 70 of a roller conveyor or other device. The stator 66 and rotor 68 may be internally pressurized and/or lubricated through ports 72a (shown in FIGS. 7 and 9). This arrangement allows for the flow of air or lubricant through the labyrinth of the seal, exiting below an interior portion of fins (shown in FIGS. 8 and 9) of the rotor 68 and forming a bubble of air or lubricant that isolates physical contact between intermeshing surfaces of the bearing seal 64 and, for example, molten zinc. This reduces or eliminates abrasion of and wear to the bearing seal 64.

FIG. 7 illustrates the stator 66 according to one embodiment of the invention. The stator 66 may include an extended portion 72. The extended portion 72 of the stator 66 may be received by the top portion 44 and the bottom portion 46 of the housing 42 using receiving portions 50. The extended portion 72 helps to substantially prevent corrosive, abrasive or other materials from entering the housing 42.

FIG. 8 illustrates the rotor 68 according to one embodiment of the invention. The rotor 68 may include one or more fins 74. According to one embodiment of the invention, the housing 42 is pressurized with air and/or lubricant 56 to substantially prevent corrosive, abrasive or other material from entering the housing 42. The fins 74 may be used in conjunction with the pressurized housing 42 to substantially isolate components provided within the housing 42 by forcing material away from the bearing seal 64.

FIG. 9 is a partial cross-sectional view of the bearing seal 64 according to one embodiment of the invention. The bearing seal 64 may include the stator 66 and the rotor 68. The stator 66 and the rotor 68 may be provided about the shaft 70. The extended portion 72 of the stator 66 may be received by one or more of the receiving portions 50 of the housing 42 of the bearing assembly 40. The extended portion 76 of the rotor 68 may be at least partially received by the stator 66. The rotor 68 may also include a drive ring 78 that may assist in rotating the rotor 68. The stator 66 may include an o-ring 80 that may be used to maintain the stator 66 in a desired location. The bearing seal 64 may also include an air pressure bleed that operates to reduce or prevent physical contact between mating surfaces of the bearing seal 64 and a corrosive and/or abrasive environment such as, for example, a molten metal bath.

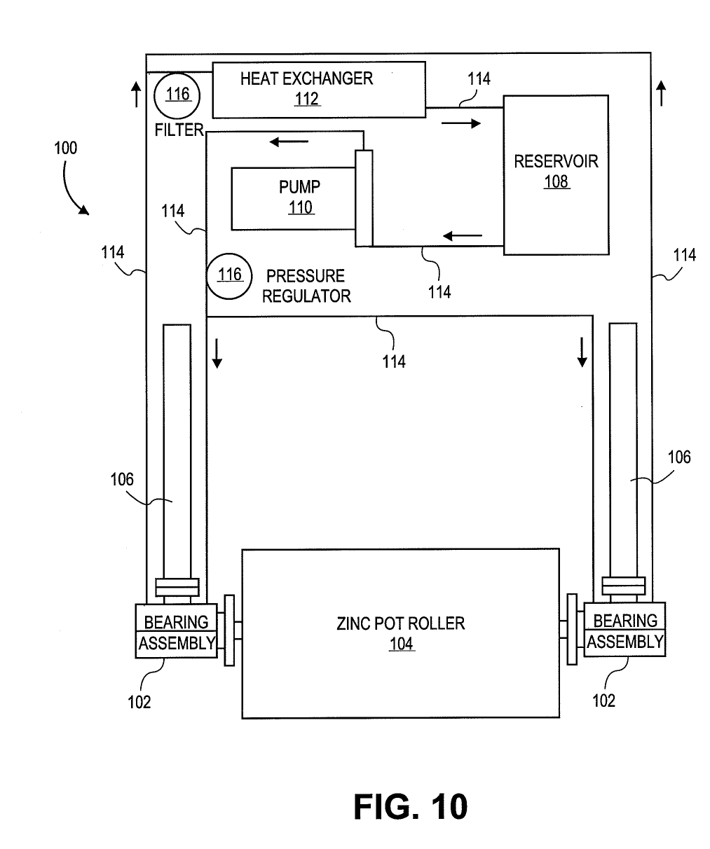

FIG. 10 illustrates a steel sheet galvanizing system 100 that may use bearing assemblies 102 according to the invention. The bearing assemblies 102 may be operatively coupled to a zinc pot roller 104 and swing arms 106 of, for example, a roller conveyor or other device. The galvanizing system 100 may also include a reservoir 108 that is in fluid communication with a pump 110 and a heat exchanger 112. The galvanizing system 100 may also include tubing 114 that provides a closed-loop lubricating system for providing a lubricant to the bearing assemblies 102. According to one embodiment of the invention, the reservoir 108 stores a lubricant such as, for example, oil. The oil is forced from the reservoir 108 by the pump 110 and enters the bearing assemblies 102 through tubing 114. The oil exits the bearing assemblies 102 through tubing 114 and enters the heat exchanger 112. The oil exits the heat exchanger 112 and returns to the reservoir 108. A pressure regulator 116 may also be provided to regulate the pressure within the reservoir 108 and/or the bearing assemblies 102.

Additionally, a filter 118 may be provided to filter the lubricant and remove contaminants or other material from the lubricant. According to one embodiment, the filter 118 may be provided between the bearing assemblies 102 and the heat exchanger 112.

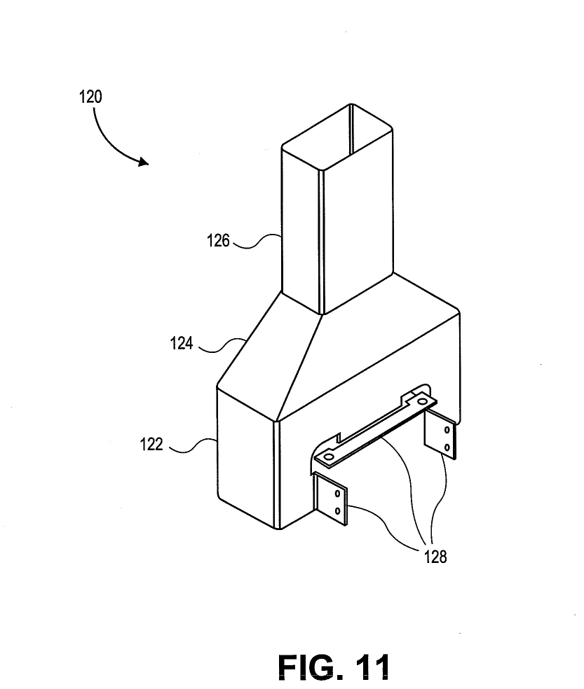

FIG. 11 illustrates a hood 120 for a bearing assembly according to one embodiment of the invention. The hood 120 may be formed of, for example, a unitary sheet of 316 grade stainless steel or other suitable material. The hood 120 includes a lower portion 122, middle portion 124, and upper portion 126. The lower, middle, and upper portions 122, 124, and 126, respectively, may be formed of, for example, a unitary sheet of 316 grade stainless steel or other suitable material. The lower portion 122 includes mounting brackets 128 that enable the hood 120 to be mounted to the bearing assembly using, for example, rivets, screws or other fastening mechanisms.

The lower portion 122 may be rectangularly shaped and include a cut-out portion on one side from which the mounting brackets 128 may extend. The middle portion 124 may be funnel-shaped such that a larger end of the middle portion 124 is connected to the lower portion 122 and a narrower end is connected to the upper portion 126. The upper portion 126 may be substantially rectangularly shaped. This arrangement facilitates isolating lubricants or gases expelled from the bearing assembly from contacting a steel coil or other product being galvanized. The hood 120 also facilitates any expelled lubricant or gas being collected or vented.

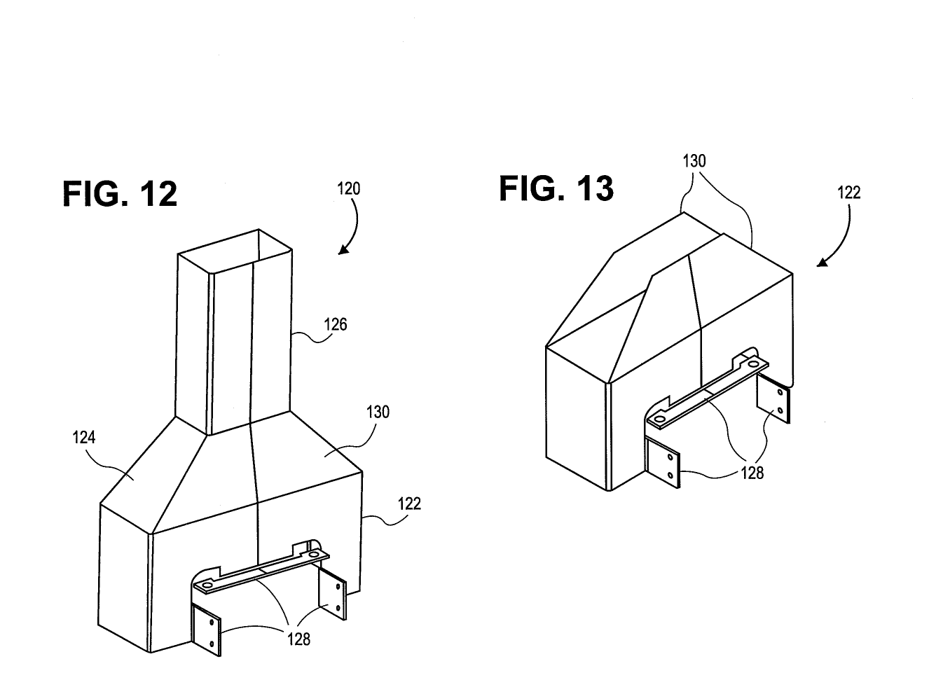

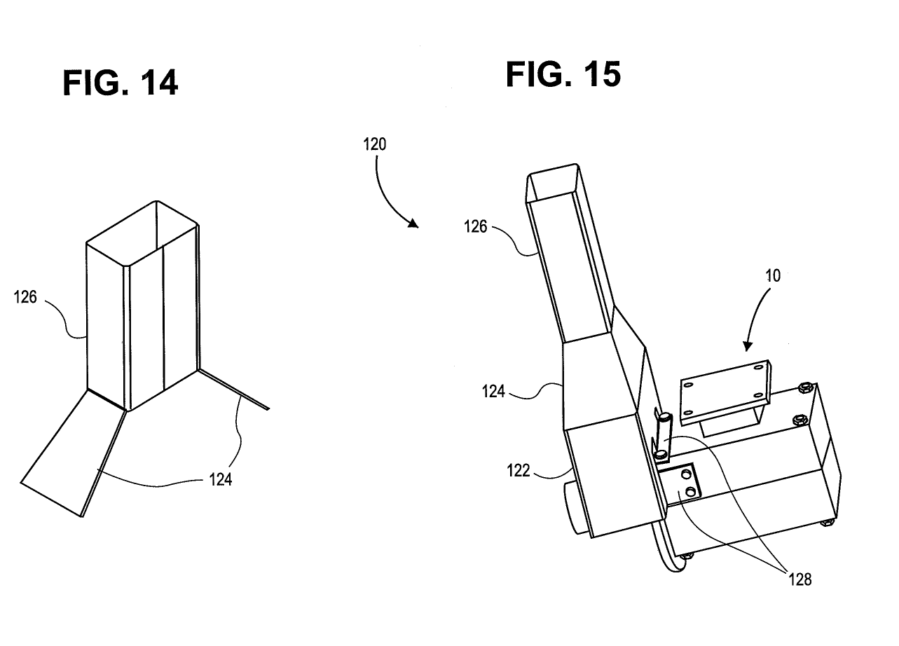

FIGS. 12-14 illustrate one embodiment of the hood 120 in which the lower portion 122 and a portion of the middle portion 124 are formed from a first sheet of material and the upper portion 126 and a remaining portion of the middle portion 124 are formed from a second sheet of material. The first and second sheets of material may be bent to form the lower, middle, and upper portions 122, 124, and 126, respectively. For example, the first sheet may be bent to form the lower portion 122, front and rear sides 130 of the middle portion 124, and the mounting brackets 128 as shown in FIGS. 12-13. The second sheet may be bent to form the upper portion 126 and the sides of the middle portion 124 as shown in FIG. 14. The sheets may then be secured together to form the hood 120 as shown in FIG. 12. The

FIG. 15 illustrates a hood 120 having lower, middle, and upper portions 122, 124, and 126, respectively, secured to a bearing assembly 10 using mounting brackets 128 according to one embodiment of the invention. As shown, the hood 120 is secured to one end of the bearing assembly 10 and covers a portion of a bearing seal and shaft of the bearing assembly. Thus, lubricants or gases expelled from the bearing seal enter the hood 120 and are isolated from the surrounding area. According to one embodiment of the invention, the hood 120 is at least partially immersed in a galvanizing bath and extends out of the galvanizing bath. This serves to prevent lubricants or gases from contacting a steel coil or other product being galvanized in the galvanizing bath. The lower portion 122 of the hood 120 may also include a cut-out opposite the mounting brackets 128 through which a shaft of the bearing assembly may pass.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hood and a bearing assembly comprising:
a lower portion;
a middle portion secured to the lower portion, wherein the middle portion comprises a first end and a second end;
an upper portion secured to the middle portion; and
mounting brackets that secure the hood to the bearing assembly.

2. The hood of claim 1, wherein the lower, middle, and upper portions comprise 316 grade stainless steel.

3. The hood of claim 1, wherein the first end is wider than the second end.

4. The hood of claim 1, wherein the first end is secured to the lower portion and the second end is secured to the upper portion.

5. The hood of claim 1, wherein the lower, middle, and upper portions are formed from a unitary sheet of material.

6. The hood of claim 1, wherein the lower, middle, and upper portions are formed from a first sheet of material and a second sheet of material.

7. The hood of claim 6, wherein the first sheet of material forms the lower portion and a portion of the middle portion.

8. The hood of claim 6, wherein the second sheet of material forms the upper portion and a portion of the middle portion.

9. The hood of claim 1, wherein the hood is secured to the bearing assembly.

10. The hood of claim 9, wherein the hood is secured to the bearing assembly using any one of rivets and screws.

11. A hood for a bearing assembly comprising:
a lower portion;
a middle portion secured to the lower portion, wherein the middle portion comprises a first end and a second end, wherein the first end is wider than the second end, and wherein the first end is secured to the lower portion and the second end is secured to the upper portion;
an upper portion secured to the middle portion; and
mounting brackets for securing the hood to a bearing assembly.

12. The hood of claim 11, wherein the lower, middle, and upper portions comprise 316 grade stainless steel.

13. The hood of claim 11, wherein the lower, middle, and upper portions are formed from a unitary sheet of material.

14. The hood of claim 11, wherein the lower, middle, and upper portions are formed from a first sheet of material and a second sheet of material.

15. The hood of claim 14, wherein the first sheet of material forms the lower portion and a portion of the middle portion.

16. The hood of claim 14, wherein the second sheet of material forms the upper portion and a portion of the middle portion.

17. The hood of claim 11, wherein the hood is secured to the bearing assembly.

18. A hood for a bearing assembly comprising:
a lower portion;
a middle portion secured to the lower portion, wherein the middle portion comprises a first end and a second end, the first end is wider than the second end, the first end is secured to the lower portion and the second end is secured to the upper portion, the lower, middle, and upper portions are formed from a first sheet of material and a second sheet of material, the first sheet of material forms the lower portion and a portion of the middle portion, and the second sheet of material forms the upper portion and a portion of the middle portion;
an upper portion secured to the middle portion; and
mounting brackets for securing the hood to a bearing assembly.

19. The hood of claim 18, wherein the lower, middle, and upper portions comprise 316 grade stainless steel.

20. The hood of claim 18, wherein the hood is secured to the bearing assembly.
